(19) United States
(12) Patent Application Publication
(10) Pub. No.: US 2005/0286002 A1
(43) Pub. Date: Dec. 29, 2005

(54) Image display apparatus and method of manufacturing image display apparatus

(75) Inventor: Hisao Tajima, Yokohama-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/152,177

(22) Filed: Jun. 15, 2005

(30) Foreign Application Priority Data
Jun. 29, 2004 (JP) 2004-191427
May 10, 2005 (JP) 2005-137312

(51) Int. Cl. G02F 1/1343

(52) U.S. Cl. 349/139

(57) ABSTRACT

A method of manufacturing an image display apparatus comprises the steps of: arranging an electrically conductive member such that at least a part of said electrically conductive member is located between an image display panel and a drive circuit, said electrically conductive member having a hole which passes wiring, said wiring connecting said image display panel and said drive circuit for driving said image display panel; locating said wiring in the hole, said wiring connecting said image display panel and said drive circuit; and pushing an electrically-conductive elastic member into the hole.

### BACKGROUND OF THE INVENTION

1. Field of the Invention

The present invention relates to an image display apparatus which is used for a television and a monitor and a method of manufacturing the image display apparatus.

2. Related Background Art

In the image display apparatus which is one of information devices, it is necessary that electromagnetic wave intensity leaking to the outside of the apparatus is suppressed below a permissive limit. Therefore, it is necessary to decrease the electromagnetic wave leakage.

For example, in order to decrease the electromagnetic wave leakage, a PDP (Plasma Display Panel) image display apparatus proposed in Japanese Patent Application Laid-Open No. H11-219122 provides an electromagnetic wave shielding space by adopting a structure in which a conductive screen filter (front plate), a shield member (shield case), and a gasket are combined. In the structure of the electromagnetic wave shielding space, an image display panel is covered with the conductive screen filter located on the front face side of the image display panel and the frame-like shield case extending the front side to the rear side of the image display panel.

An object of the invention is to decrease the electromagnetic wave leaking from the front face of the image display apparatus.

### SUMMARY OF THE INVENTION

A first aspect of the invention is a method of manufacturing an image display apparatus, the method including the steps of arranging an electrically conductive member such that at least a part of the electrically conductive member is located between an image display panel and a drive circuit, the electrically conductive member having a hole which passes wiring, the wiring connecting the image display panel and the drive circuit for driving the image display panel; locating the wiring in the hole, the wiring connecting the image display panel and the drive circuit; and pushing an electrically-conductive elastic member into the hole.

A second aspect of the invention is a method of manufacturing an image display apparatus, the method including the steps of arranging an electrically conductive member such that at least a part of the electrically conductive member is located between an image display panel and a drive circuit; and compressing an electrically-conductive elastic member by pressing another electrically conductive member against the electrically conductive member through the electrically-conductive elastic member, the another electrically conductive member being different from the electrically conductive member, wherein wiring is pressed against the electrically conductive member or the another electrically conductive member by the step of compressing the elastic member, the wiring connecting the image display panel and the drive circuit.

A third aspect of the invention is an image display apparatus including an image display panel; a drive circuit which drives the image display panel; an electrically conductive member which is located between the image display panel and the drive circuit, the electrically conductive member having a hole; wiring which connects the image display panel and the drive circuit through the hole; and an elastic member which has electrical conductivity, the elastic member being arranged so as to fill the hole while compressed.

A fourth aspect of the invention is an image display apparatus comprising an image display panel; a drive circuit which drives the image display panel; wiring which connects the image display panel and the drive circuit; an electrically conductive member which has a hole through which the wiring is passed; and an elastic member having electrically conducting properties is arranged so as to fill the hole while compressed, wherein the electrically conductive member and the elastic member form an electromagnetic wave shielding structure between a space where the image display panel is located and a space where the drive circuit is located.

### BRIEF DESCRIPTION OF THE DRAWINGS

FIG. 1 is an external view showing an image display apparatus according to a first embodiment of the invention;

FIG. 2 is a longitudinal sectional view taken along line 2-2 in FIG. 1;

FIG. 3 is an enlarged view showing a main portion of FIG. 2;

FIG. 4 is an external view showing an image display apparatus according to a second embodiment of the invention;

FIG. 5 is a longitudinal sectional view taken along line 5,7-5,7 in FIG. 4;

FIG. 6 is an enlarged view showing a main portion of FIG. 5; and

FIG. 7 is a longitudinal sectional view, taken along line 5,7-5,7 in FIG. 4, showing an image display apparatus according to a third embodiment of the invention.

### DETAILED DESCRIPTION OF THE PREFERRED EMBODIMENTS

Referring now to the accompanying drawings, preferred embodiments of an image display apparatus according the invention will be described in detail.

In an electrically conductive member of the invention, a sheet resistance of the surface is not more than 10⁹ (Ω/□).

The electromagnetic wave shielding structure shall include not only the structure which can shield the electromagnetic wave transmission but also the structure which can suppress the electromagnetic wave transmission.

First Embodiment

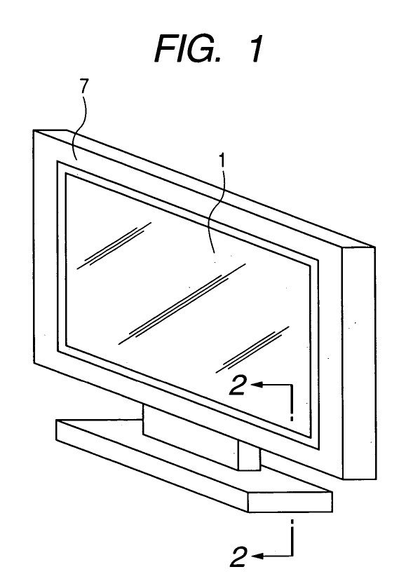

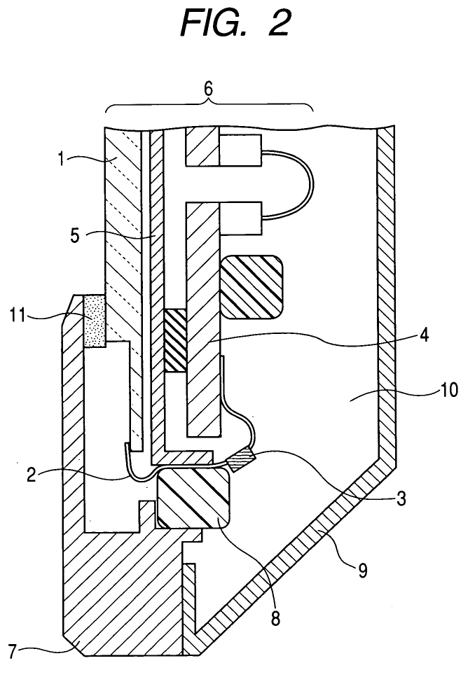

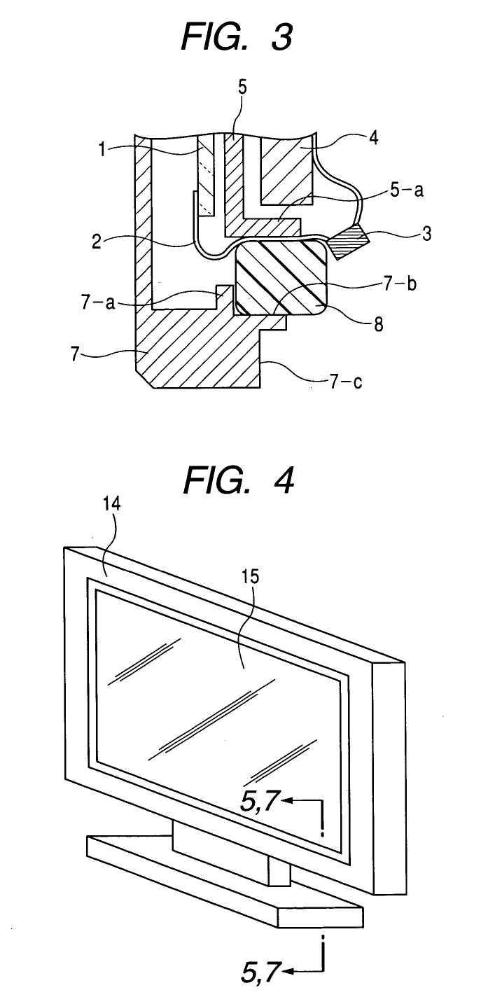

Referring to FIGS. 1 to 3, a first embodiment of the invention will be described below. FIG. 1 is an external view showing an image display apparatus of the first embodiment, FIG. 2 is a longitudinal sectional view taken along line 2-2 in FIG. 1, and FIG. 3 is an enlarged view showing a main portion of FIG. 2.

The reference numeral 1 denotes a thin image display panel which forms a vacuum vessel with two glass substrates and a frame member. Electric wiring and electron emission elements (not shown) are formed in a matrix shape on the vacuum side of the glass substrate (rear plate) located on the rear side. The electric wiring extends to a peripheral end portion of the glass substrate, and the peripheral end portion is located outside the vacuum vessel. Light-emitting members having three primary colors of R, G, and B and an electrically conductive metal film are formed on the vacuum side surface of the glass substrate (front plate) located on the front side. A low-reflection layer, an antistatic layer, a dirt protection layer, and a contrast adjusting layer are formed on the atmospheric side opposite to the vacuum side surface by bonding one or plural functional films one another.

The reference numeral 2 denotes TCP (Tape Carrier Package) wiring which connects the image display panel 1 and the later-mentioned X-driver substrate. The TCP wiring 2 is a thin cable having flexibility for bending. In the TCP wiring 2, copper-alloy leads (not shown) are formed at desired intervals between insulating film base materials. Although FIGS. 2 and 3 show the structure in which the TCP wiring 2 is arranged in a lower portion of the image display panel 1, the TCP wiring 2 are arranged across all the peripheries of four sides of the image display panel 1 as a whole. A connection portion between the TCP wiring 2 and the image display panel 1 is bonded onto the electric wiring through an anisotropic conductive film (not shown). The electric wiring extends to the peripheral end portion of the glass substrate of the image display panel 1. The TCP wiring 2 corresponds to the wiring of the invention.

The reference numeral 3 denotes IC mounted on the TCP wiring 2. Plural connection terminals (not shown) on the input side are formed in the TCP wiring 2, and the connection terminals are connected to connection terminals of the X-driver substrate. On the other hand, connection terminals (not shown) on the output side are connected to the connection wiring of the image display panel 1. IC 3 has a function of converting a modulating signal outputted from the X-driver substrate into a drive signal with which the image display panel 1 can display the image.

The reference numeral 4 denotes the X-driver substrate which is installed on the later-mentioned chassis and fixed to the chassis by a screw (not shown). The signal input side of the X-driver substrate 4 is connected to a control circuit board (not shown) through the cable connected to the input terminals, and the plural connection terminal on the output side of the X-driver substrate 4 are connected to the input connection terminals of the TCP wiring 2. The X-driver substrate 4 has the function of transmitting the modulating signal, outputted from the control circuit board, to IC 3 through the TCP wiring 2 while maintaining quality of a signal wave form.

The reference numeral 5 denotes the chassis which is arranged so as to face the glass substrate (rear plate) located on the rear side of the image display panel 1. The chassis 5 supports the image display panel 1 by a bonding agent (not shown). Further, the X-driver substrate 4 and other electric circuit boards (not shown) such as a control circuit, a signal processing circuit, a power supply circuit, a high-voltage power supply circuit, and a tuner are mounted on the opposite side to the image display panel 1 of the chassis 5. The chassis 5 is directly connected to ground wiring (not shown) of the image display panel 1, and the chassis 5 is also connected to the ground wiring of the electric circuit boards including the X-driver substrate by utilizing the screws for fixing the electric circuit boards. The chassis 5 corresponds to the electrically conductive member of the invention.

The chassis 5 of the first embodiment, all the peripheries are bent to the rear side by press working of an aluminum alloy plate, and projections and crew holes for fixing the electric circuit boards onto the chassis 5 are also made by the press working. IC 3 and the electric circuit boards including the X-driver substrate 4 mounted on the chassis 5 correspond to the drive circuit of the invention.

The reference numeral 6 denotes an image display module which includes the image display panel 1, the TCP wiring 2, IC 3, the X-driver substrate 4, the chassis 5, and the electric circuit boards mounted on the chassis 5.

The reference numeral 7 denotes a frame-like front cover which is bent from the front to the side of the image display module 6. The front cover 7 is attached such that a mechanical load is not applied from the outside to the image display module 6 or such that dust and moisture do not adversely affect the image display apparatus. The front cover 7 is also attached so as to maintain an appearance of the face side of the image display apparatus. The front cover 7 made of the aluminum alloy is integrally formed by die casting. The external surface exposed to the outside is coated (not shown) in the front cover. The front cover 7 corresponds to another electrically conductive member of the invention. Thus, the electrically conductive member can be formed by another member, and it is also possible that the electrically conductive member is formed as one constituent having a hole through which the TCP wiring 2 is passed.

The reference numeral 8 denotes an elastic member. The elastic member 8 is attached across all the peripheries of the four sides such that the elastic member 8 fills a gap between the image display module 6 and the front cover 7 while compressed. In the elastic member 8 of the first embodiment, an inner base is made of the material having elasticity such as rubber and sponge, and outer skin is formed by a composite material including a metal film or metal wire having the electrical conductivity.

In the first embodiment, as shown in FIG. 3, a thickness of the elastic member 8 is set at dimensions larger than a spatial distance between a curved portion 5-a of the chassis 5 constituting the image display module 6 and an inner wall 7-b of the front cover 7. Therefore, while the TCP wiring 2 is always pressed against the curved portion 5-a of the chassis 5, the electrical conduction is always secured between the inner wall 7-b the front cover 7 and the curved portion 5-a of the chassis 5. Further, the elastic member 8 is surrounded by a positioning portion 7-a of the front cover 7, the curved portion 5-a, and the inner wall 7-b so as not to slip away.

The reference numeral 9 denotes a convex rear cover which is arranged at a position facing the rear face of the image display module 6. The rear cover 9 is attached such that the mechanical load is not applied from the outside to the image display module 6 or such that the dust and moisture do not adversely affect the image display apparatus. The rear cover 9 is also attached so as to maintain the appearance of the rear side of the image display apparatus. The rear cover 9 made of the aluminum alloy is integrally formed by the press working. The external surface exposed to the outside is coated (not shown) in the rear cover. The rear cover 9 has the structure in which the rear cover 9 is securely in close contact with the front cover 7 at an inner wall 7-c across all the peripheries by utilizing the screws (not shown). The rear cover 9 is mechanically and electrically engaged by the screws (not shown) at a projected rear cover fixing portion (not shown) formed in the chassis 5 constituting the image display module 6.

The reference numeral 10 denotes an approximately closed space which is formed by the chassis 5 of the image display module 6, the front cover 7, the elastic member 8, and the rear cover 9. The drive circuit is located in the approximately closed space 10, which decreases the electromagnetic wave leakage. The above-described constituents, as described above, are mechanically and electrically connected to one another by the screws and the elastic force.

The reference numeral 11 denotes a dust-proof seal material. The dust-proof seal material 11 is arranged so as to fill the gap between the front cover 7 and the image display panel 1 at the peripheral four sides of the image display panel 1. The material having the elasticity is adopted in order to prevent entry of the dust and moisture to the inside of the image display apparatus.

Then, the structure and the method of driving the image display panel 1 will be described.

The image display panel 1 utilizes the electron emission element. In the operation of the image display panel 1, a voltage of ten and several volts is applied between an X-direction lead and a Y-direction lead, which are selected by the electric circuit, to emit the electron from the electron emission element. Then, the emitted electron is accelerated to a metal back film located on the vacuum gap side of the front-side glass plate (front plate) by a positive potential of ten and several kilovolts supplied from an external high-voltage power supply, and the electron collides with the fluorescent film to generate the light emission. The high-voltage application to the metal back film is performed with a dedicated cable (not shown) from the high-voltage power supply board mounted on the image display module 6 through a high-voltage terminal (not shown) attached to the rear-side glass substrate (rear plate).

The TCP wiring 2 on which IC 3 is mounted provides a selection signal to the image display panel 1 between a lower-side TCP wiring 2 and an upper-side TCP wiring 2 arranged in a symmetrical relation with respect to the image display panel 1. On the other hand, Y-TCP wiring (not shown) on which a Y-IC (not shown) is mounted on each of right and left sides of the image display panel 1. The output and a scanning control signal from a Y-driver substrate (not shown) are converted into a scanning signal by Y-IC, and the scanning signal is provided to the image display panel 1.

The reason why the electron emission element is adopted for the image display panel 1 in the first embodiment is that the electron emission element has marketability such as high image quality and low power consumption. It is also possible that the image display panels utilizing other principles, such as plasma discharge, liquid crystal, and organic EL light-emission element, are adopted for the image display panel 1.

Then, a generation source of the electromagnetic wave and the mechanism for decreasing the leakage to the outside of the chassis will be described.

In the electric signals passing through the TCP wiring 2 and the Y-TCP wiring, the electric signal inputted to IC 3 and Y-IC which are mounted the TCP wiring 2 and the Y-TCP wiring respectively generate the large amount of electromagnetic waves. In the selection signal and the scanning signal after converted by IC 3 and Y-IC, an output waveform is improved such that the electromagnetic wave is suppressed.

In the electric circuit boards mounted on the image display module 6, the electromagnetic waves having particularly high frequencies tend to be easily generated, because the image display apparatus is required to comply with the recent digitalization of the broadcasting such as multi-channel and high-definition image broadcasting. In the electric circuit board in which the electromagnetic wave having high intensity is generated, the intensity of the electromagnetic wave is decreased by shielding the electrically conductive case (not shown). However, for the purpose of heat generation measures of the elements mounted on the electric circuit board, heat dissipation holes are made in the case, and holes through which the wiring connecting the electric circuit boards are made. Therefore, it is difficult to decrease the intensity of the electromagnetic wave.

The electromagnetic waves generated from the electric circuit boards have characteristics that the electromagnetic wave is multiply reflected inside the chassis and the electromagnetic wave leaks from the gap of the chassis if the gas exists.

However, in the structure of the first embodiment, the space, in which IC 3 and Y-IC mounted on the TCP wiring 2 and the Y-TCP wiring and the electric circuit boards are located, is separated from the space on the display surface side of the image display panel 1 by the electromagnetic wave shielding structure formed by the chassis 5, the elastic member 8, and the front cover 7. Further, the chassis 5, the elastic member 8, the front cover 7, and the rear cover 9 are closely connected to one another such that the gap through which the electromagnetic wave leaks cannot be formed. The chassis 5, the elastic member 8, the front cover 7, and the rear cover 9 are set at the potential equal to the ground potential of the image display panel 1. Therefore, the chassis 5, the elastic member 8, the front cover 7, and the rear cover 9 make the approximately closed space 10, which allows IC 3, Y-IC, and the electric circuit boards to be accommodated in the approximately closed space 10.

According to the above-described structure, the large portion of the generated electromagnetic wave are absorbed in the components constituting the approximately closed space 10, and the electromagnetic wave which leaks in the forward direction from the gap between the image display panel 1 and the chassis 5 is particularly decreased.

When the components constituting the approximately closed space 10 are mechanically in close contact with one another and electrically connected to one another, the invention can be applied. Therefore, the materials and machining methods can be changed as follows.

For example, it is also possible that the chassis 5 is formed by, the die casting of the electrically conductive metal except for the aluminum alloy (e.g. a magnesium alloy) or the injection molding of thixotropic metal alloys (e.g. a magnesium alloy) in a semi-solid or plastic-like state. The chassis 5 is partially composed of steel. When the front cover 7 is formed in the frame shape by extruding and assembling the magnesium alloy, further weight reduction is preferably achieved. When the electrically conductive film is formed on the surface after the front cover 7 is integrally molded with the fire-resistant resin material, preferably production cost is further reduced. When the rear cover 9 is formed by the press working of the magnesium alloy or the injection molding of the magnesium alloy in a semi-solid or plastic-like state, the further weight reduction is preferably achieved. When the electrically conductive film is formed on the surface after the rear cover 9 is integrally molded with the fire-resistant resin material, the production cost is preferably reduced.

In attaching the elastic member 8 into the gap formed by the chassis 5 and the front cover 7, it is preferable that the use of the bonding agent including the resin material or double-faced tape further enhances connection reliability.

Examples of the method of arranging the elastic member 8 include the method of pushing the elastic member 8 into the gap formed by the chassis 5 and the front cover 7 and the method of compressing the elastic member 8 by pressing the front cover 7 against the chassis 5 through the elastic member 8.

It is also possible that the elastic member 8 is pushed in between the chassis 5 and the rear cover 9. In this case the electromagnetic wave shielding structure is formed by the chassis 5, the elastic member 8, and the rear cover 9, which results in not only the decrease in electromagnetic wave leakage from the front but also the decrease in electromagnetic wave leakage from the whole of the image display apparatus.

As described above, according to the first embodiment, the following effects can be obtained.

1) In the gap between the image display module 6 and the front cover 7, where the electromagnetic wave leaks easily in the forward direction, i.e. in the portion through which the TCP wiring 2 is passed to the image display panel 1, since the elastic member 8 presses the TCP wiring 2 against the chassis 5 at the position where IC 3 and the electric circuit boards are separated from the space on the display surface side of the image display panel 1, the electromagnetic wave leakage is decreased in the forward direction. Further, for Y-IC in the portion through which the Y-TCP wiring of each of the right and left portions of the image display panel 1 is passed, since the elastic member 8 presses the Y-TCP wiring against the chassis 5 at the position where Y-IC is separated from the space on the display surface side of the image display panel 1, the same effect is obtained.

2) The approximately closed space 10, in which IC 3, Y-IC, and the electric circuit boards are included, is formed by mechanically and electrically connecting the small number of components of the chassis 5, the front cover 7, the elastic member 8, and the rear cover 9. Therefore, the highly-reliable electromagnetic wave shielding structure is realized at low cost.

3) The electrically-connected components constituting the approximately closed space 10 are set at the potential equal to the ground potential of the image display panel 1, so that the prevention effect of the electromagnetic wave leakage is improved.

4) In gap portion between the image display module 6 and the front cover 7, the elastic member 8 having the elasticity is sandwiched by utilizing the positioning portion provided in the front cover 7. Therefore, the assembly is easy, and the high reliability is obtained in the electric connection.

5) Since the front plate does not exist in front of the image display panel 1 unlike the conventional image display apparatuses, brightness of the image display is not decreased, and the electric power of the image display can be saved.

Second Embodiment

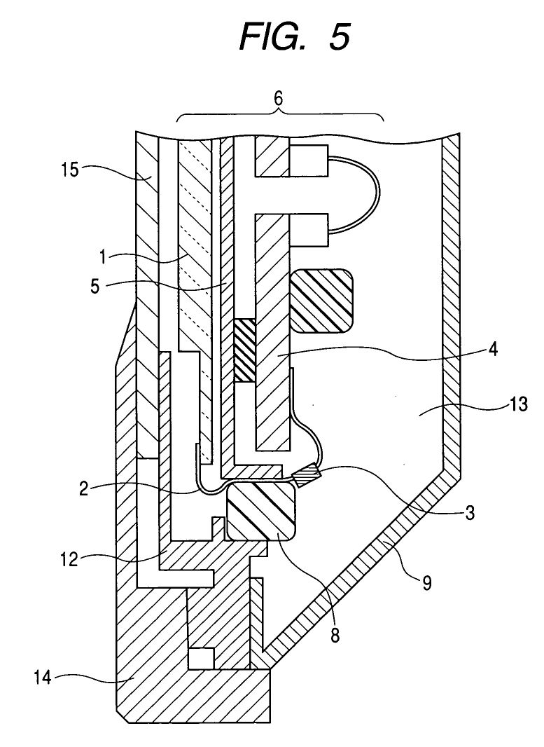

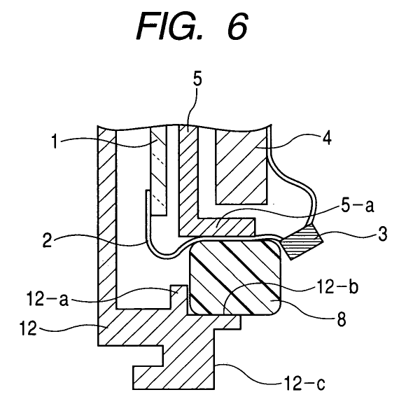

Referring to FIGS. 4 to 6, a second embodiment of the invention will be described below. FIG. 4 is an external view showing an image display apparatus of the second embodiment, FIG. 5 is a longitudinal sectional view taken along line 5,7-5,7 in FIG. 4, and FIG. 6 is an enlarged view showing a main portion of FIG. 5. The component and means having the same function and structure as for the first embodiment are indicated by the same reference numeral as for the first embodiment, and the descriptions will be omitted.

The reference numeral 12 denotes a frame portion which is bent from the front to the side of the image display module 6. In the frame portion 12, an attachment portion to which the later-mentioned front plate is attached is formed in the front portion, and an inner wall 12-c to which the rear cover 9 is connected by the screw is formed in a rear portion. The attachment portion and the inner wall 12-c are integrally formed by the die casting of the aluminum alloy. The frame portion 12 corresponds to another electrically conductive member of the invention.

The elastic member 8 having both the elasticity and the electrical conductivity is also adopted in the second embodiment.

In the second embodiment, as with the first embodiment, the thickness of the elastic member 8 is set at dimensions larger than the spatial distance between the curved portion 5-a of the chassis 5 and the inner wall 12-b of the frame portion 12. Therefore, while the TCP wiring 2 is always pressed against the curved portion 5-a of the chassis 5, the electrical conduction is always secured between the inner wall 12-b of the frame portion 12 and the curved portion 5-a of the chassis 5. Further, the elastic member 8 is surrounded by a positioning portion 12-a of the frame portion 12, the curved portion 5-a, and the inner wall 12-b so as not to slip away.

The reference numeral 13 denotes an approximately closed space which is formed by the chassis 5 of the image display module 6, the frame portion 12, the elastic member 8, and the rear cover 9. The above-described constituents, as described in the first embodiment, are mechanically and electrically connected to one another by the screws and the elastic force.

The reference numeral 14 denotes a front cover. The front cover 14 is attached such that the mechanical load is not applied from the outside to the image display module 6 or such that the dust and moisture do not adversely affect the image display apparatus. The front cover 14 is also attached so as to maintain the appearance of the face side of the image display apparatus. The front cover 14 is integrally formed by injection molding of the resin material. Further, character print (not shown) is performed in the external surface exposed to the outside.

The reference numeral 15 denotes a front plate which is placed in front of the image display panel 1 while facing the image display panel 1. The front plate 15 protects the image display panel 1 from collision of the outside foreign matter and the dust. The contrast adjusting layer, the low-reflection layer, the antistatic layer, and the dirt protection layer are laminated on the front-side surface of a sheet of blue glass. The frame is formed in the backside of the sheet of blue glass by the silk-screen printing, and the light within the image display range of the image display panel 1 can be transmitted through the inside of the frame. In the attachment, the peripheral portion of the front plate 15 is bonded to the frame portion 12 by the double-side tape (not shown) and supported by the frame portion 12.

The correlation and function of the image display panel 1 and the front plate 15 in the structure of the second embodiment will be described below so that the difference between the second embodiment and the first embodiment becomes obvious.

In the first embodiment, the low-reflection layer, the antistatic layer, the dirt protection layer, and the contrast adjusting layer are formed on the atmospheric side of the front-side glass plate (front plate) of the image display panel 1 by bonding one or plural functional films. On the contrary, according to the second embodiment, the front plate 15 is attached in front of the image display panel 1. Therefore, a low-reflection process and a contrast adjustment for improving the quality of the display image become unnecessary, and the dirt and dust hardly adheres, which results in removal of the surface treatment of the image display panel 1. Accordingly, the process of manufacturing the image display panel 1 is simplified when compared with the first embodiment.

It is also possible that the low-reflection layer is provided in the backside of the front plate 15. In this case, the contrast of the displayed image is further improved, which increases viewability of the displayed image. The thin film whose sheet resistance ranges from 10⁶ (Ω/□) to 10⁸ (Ω/□) is used as the antistatic layer of the front surface, and the thin film made of a fluororesin is used as the dirt protection layer. A low-refractive-index material and a high-refractive-index material, such as silicon oxide and titanium oxide, are laminated in the low-reflection layer.

The generation source of the electromagnetic wave and the mechanism in which the electromagnetic wave leakage to the outside of the chassis is decreased will be described below.

The TCP wiring 2 and the Y-TCP wiring, IC 3 and Y-IC mounted on the TCP wiring 2 and the Y-TCP wiring respectively, and the functions and arrangements of the electric circuit boards mounted on the image display module 6 are similar to the first embodiment. Therefore, the electromagnetic wave leakage is suppressed in the forward direction by the chassis 5, the frame portion 12, and the elastic member 8. Further, IC 3, Y-IC, and the electric circuit boards mounted on the image display module 6 are accommodated in the approximately closed space 13 by combining the chassis 5, the frame portion 12, the elastic member 8, and the rear cover 9. Therefore, the electromagnetic wave leakage to the outside of the chassis can be decreased.

Further, the chassis 5, the frame portion 12, the elastic member 8, and the rear cover 9 which constitute the approximately closed space 13 are closely connected to one another such that the gap through which the electromagnetic wave leaks cannot be formed. The chassis 5, the frame portion 12, the elastic member 8, and the rear cover 9 are set at the potential equal to the ground potential of the image display panel 1. Therefore, the large amount of electromagnetic waves generated is absorbed in the components constituting the approximately closed space 13.

In the frame portion 12 constituting the approximately closed space 13, when the adjacent components are in close contact with each other and electrically connected to each other, the invention can be applied. Therefore, in addition to the die casting, it is preferable that the extruded materials are cut in a desired length to assemble the materials in the frame shape, or it is preferable that the aluminum alloy is replaced by the other materials having the electrical conductivity such as the magnesium alloy. Further, it is preferable that electrical conductive film process is performed to the surface after the injection molding of the resin material. In these cases, the weight reduction can be achieved and the cost reduction can be realized.

As described above, according to the second embodiment, the following effects can be obtained.

1) Since the front of the image display panel 1 is covered with the front plate 15, the image display panel 1 is protected from the collision of the foreign matter or the dust, and the manufacturing process is simplified and the yield is improved. Further, there is an advantage form the viewpoint of cost.

2) In the front plate 15 with which the front of the image display panel 1 is covered, since the electrical resistance is high in the antistatic layer and the thickness of the antistatic layer can be thinned. Further, the refractive index becomes relatively high, so that the brightness of the image display is not decreased, the electric power of the image display can be saved, and the production cost of the front plate is also reduced.

3) In the gap between the image display module 6 and the frame portion 12, where the electromagnetic wave leaks easily in the forward direction, i.e. in the portion through which the TCP wiring 2 is passed to the image display panel 1, since the elastic member 8 presses the TCP wiring 2 against the chassis 5 at the position where IC 3 and the electric circuit boards are separated from the space on the display surface side of the image display panel 1, the electromagnetic wave leakage is decreased in the forward direction. Further, for Y-IC in the portion through which the Y-TCP wiring of each of the right and left portions of the image display panel 1 is passed, since the elastic member 8 presses the Y-TCP wiring against the chassis 5 at the position where Y-IC is separated from the space on the display surface side of the image display panel 1, the same effect is obtained.

4) The approximately closed space 13, in which IC 3, Y-IC, and the electric circuit boards are included, is formed by mechanically and electrically connecting the small number of components of the chassis 5, the frame portion 12, the elastic member 8, and the rear cover 9. Therefore, the highly-reliable electromagnetic wave shielding structure is realized at low cost.

5) The electrically-connected components constituting the approximately closed space 13 are set at the potential equal to the ground potential of the image display panel 1, so that the prevention effect of the electromagnetic wave leakage is improved.

6) In gap portion between the image display module 6 and the frame portion 12, the elastic member 8 having the elasticity is sandwiched by utilizing the positioning portion provided in the frame portion 12. Therefore, the high reliability is obtained in the electric connection, and good assembly properties are obtained.

Third Embodiment

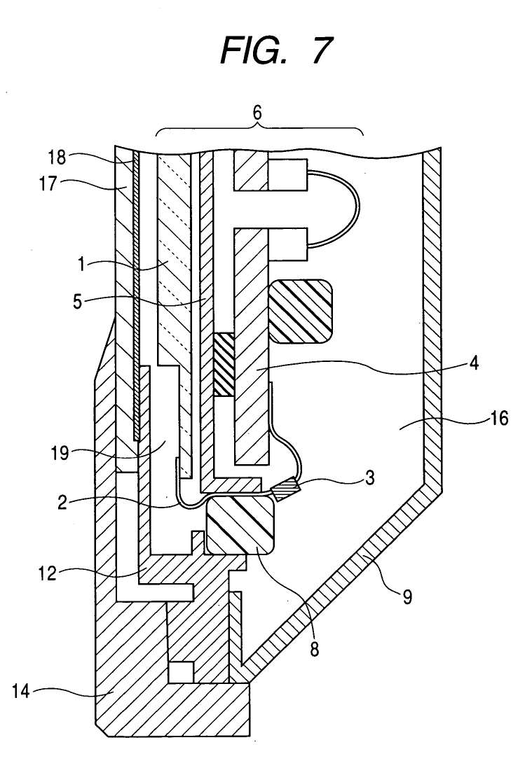

Referring to FIG. 7, a third embodiment of the invention will be described below. FIG. 7 is a longitudinal sectional view, taken along line 5,7-5,7 in FIG. 4, showing a main portion of an image display apparatus of the third embodiment. The component and means having the same function and structure as for the first and second embodiments are indicated by the same reference numeral as for the first and second embodiments, and the descriptions will be omitted.

The reference numeral 16 denotes a first approximately closed space which is formed by the chassis 5 of the image display module 6, the frame portion 12, the elastic member 8, and the rear cover 9. The above-described constituents, as described in the first and second embodiments, are mechanically and electrically connected to one another by the screws and the elastic force.

The reference numeral 17 denotes a front plate which is placed in front of the image display panel 1 while facing the image display panel 1. The front plate 15 protects the image display panel 1 from collision of the outside foreign matter and the dust. The contrast adjusting layer, the low-reflection layer, the antistatic layer, and the dirt protection layer are laminated on the front-side surface of a sheet of blue glass. The frame is formed in the backside of the sheet of blue glass by the silk-screen printing, and the light within the image display range of the image display panel 1 can be transmitted through the inside of the frame. In the attachment, the thickness of the front plate 17 is set at dimensions larger than the gap between the frame portion 12 and the front cover 14 by 5% to 10%, and the front plate 17 is sandwiched between the frame portion 12 and the front cover 14. Further, the peripheral portion of the front plate 17 is bonded to the front cover 14 by the double-side tape (not shown) and supported by the front cover 14.

The reference numeral 18 denotes an electrically conductive film which is formed in the backside of the front plate 17. In the electrically conductive film 18, the metal thin film having sheet resistance of about 10³ (Ω/□) or the film to which an ionic conduction polymer is applied is bonded to the sheet of blue glass constituting the front plate 17 by an acrylic pressure sensitive adhesive. As described above, the front plate 17 is sandwiched by the front cover 14 and the frame portion 12 and the front plate 17 always receives the pressure, and the electrically conductive film 18 is in contact with the frame portion across all the peripheries to have the electrical conduction.

The reference numeral 19 denotes a second approximately closed space which is formed by the chassis 5 of the image display module 6, the frame portion 12, the elastic member 8, and the electrically conductive film 18 of the front plate 17. The above-described constituents are mechanically and electrically connected to one another by the elastic force of the elastic member 8 and sandwiching pressure between the frame portion 12 and the front cover 14.

The correlation and function of the image display panel 1 and the front plate 15 in the structure of the third embodiment will be described below so that the difference between the third embodiment and the first and-second embodiments becomes obvious.

As with the second embodiment, the front plate 17 is attached in front of the image display panel 6. Therefore, the surface treatment to the atmospheric side of the front-side glass substrate (front plate) constituting the image display panel 1, such as the low-reflection process and contrast adjustment for improving the quality of the display image, becomes unnecessary. Further, the dirt protection process and antistatic process for causing the dirt and dust to hardly adhere are removed. Therefore, the process of manufacturing the image display panel 1 is simplified when compared with the first embodiment.

In the front plate 16 of the second embodiment, the antistatic layer having the electric conductivity is arranged on the front side. On the other hand, in the front plate 17 of the third embodiment, the electrically conductive film 18 is arranged in the backside. This is because the electrically conductive film 18 is utilized for the decrease in electromagnetic wave leakage as described later.

As with the second embodiment, in the front plate 17, the thin film made of the fluororesin is used as the dirt protection layer, and the low-refractive-index material and high-refractive-index material, such as silicon oxide and titanium oxide, are laminated in the low-reflection layer.

The generation source of the electromagnetic wave and the mechanism in which the electromagnetic wave leakage to the outside of the chassis is decreased will be described below.

The TCP wiring 2 and the Y-TCP wiring, IC 3 and Y-IC mounted on the TCP wiring 2 and the Y-TCP wiring respectively, and the functions and arrangements of the electric circuit boards mounted on the image display module 6 are similar to the first and second embodiments. Therefore, the electromagnetic wave leakage can be decreased by accommodating the TCP wiring 2 and the Y-TCP wiring, IC 3 and Y-IC, and the electric circuit boards in the first approximately closed space 16.

However, when the decrease in electromagnetic wave leakage level is required, e.g. when the official permissive limit is changed to the more strict value in the future, the new countermeasure is required. In this case, the third embodiment is particularly effective. Namely, there is the extremely slight electromagnetic wave which leaks from the first approximately closed space 16. For example, a noise component added onto the TCP wiring 2 and Y-TCP wiring is transmitted to the image display panel 1 to leak in the forward direction, or the noise component leaks from the slight gap between the elastic member 8 and the TCP wiring 2 and Y-TCP wiring. The second approximately closed space 19 of the third embodiment functions so that the electromagnetic waves do not leak outside the chassis of the image display apparatus. The chassis 5, the frame portion 12, the elastic member 8, and the electrically conductive film 18 of the front plate 17 which constitute the second approximately closed space 19 are closely connected to one another such that the gap through which the electromagnetic wave leaks cannot be formed. The chassis 5, the frame portion 12, the elastic member 8, and the electrically conductive film 18 are set at the potential equal to the ground potential of the image display panel 1. Therefore, the large amount of electromagnetic waves generated is absorbed.

Further, when the components constituting the second approximately closed space 19 are mechanically in close contact with one another and electrically connected to one another, the invention can be applied. Therefore, even if the adhesion to the front plate 17 is changed to the electrically conductive bonding agent or the electrically conductive double-face tape to fix the front plate 17 to the frame portion 12 side, the same effects are obtained. At this point, since it is not necessary that the front plate 17 is not sandwiched by the frame portion 12 and the front cover 14, the dimensional restriction is eliminated between the frame portion 12 and the front cover 14, which results in the effect of cost reduction.

As described above, according to the second embodiment, the following effects can be obtained.

1) The first approximately closed space 16 which decreases the electromagnetic wave is formed by mechanically and electrically connecting the small number of components of the chassis 5, the frame portion 12, the elastic member 8, and the rear cover 9. Therefore, the highly-reliable electromagnetic wave shielding structure is realized at low cost.

2) The second approximately closed space 19 which prevents the electromagnetic wave is formed by the chassis 5, the frame portion 12, the elastic member 8, and the electrically conductive film 18 of the front plate 17. Therefore, the electromagnetic wave generated from the noise passing through the TCP wiring 2 and the leakage electromagnetic wave from the extremely slight gap between the TCP wiring 2 and the elastic member 8 are decreased. Needless to say, the electromagnetic wave generated from the noise passing through the Y-TCP wiring and the leakage electromagnetic wave from the extremely slight gap between the Y-TCP wiring and the elastic member 8 are also decreased.

3) In the components constituting the first approximately closed space 16 and the second approximately closed space 19, the potentials are set equal to the ground potential of the image display panel 1. Therefore, the prevention effect of the electromagnetic wave leakage is improved.

4) The image display apparatus of the third embodiment has the structure in which the front plate 17 constituting the second approximately closed space 19 is bonded to the front cover 14 and sandwiched between the front cover 14 and the frame portion 12, or the structure in which the front plate 17 is fixed to the frame portion 12 by the electrically conductive bonding means, the assembly becomes simple and reliability is enhanced in the electric connection.

In the third embodiment, the TCP wiring 2 is pressed against the chassis 5 by the elastic member 8. However, it is also possible that the TCP wiring 2 is pressed against the front cover 7 or the frame portion 12.

The effects of the first to third embodiments are summarized as follows:

1) The space, in which the electric circuit boards including the X-driver substrate at the back of the chassis and IC provided on the TCP wiring connecting the image display panel and the electric circuit boards are included, is separated from the space on the display surface side of the image display panel by the chassis which is of the electrically conductive member at the back of the image display panel constituting the image display apparatus, the electrically-conductive frame-like member (the front cover in the first embodiment, and the frame portion in the second and third embodiments), and the elastic member which is of the electrically-conductive pressing member. Therefore, the electromagnetic wave leakage can be decreased in the forward direction of the image display apparatus (first to third embodiments).

2) Since the rear cover is added, the electromagnetic wave leakage to the outside of the chassis of the image display apparatus can further be decreased by the small number of components (first to third embodiments).

3) Since the constituent components of the electromagnetic wave shielding structure is equal to the image display panel in the ground potential, the prevention effect of the electromagnetic wave leakage is further improved (first to third embodiments).

4) The elastic member is securely attached to the electrically-conductive frame-like member, and the elastic member is electrically securely connected to the electrically-conductive frame-like member. Therefore, the reliability of the electromagnetic wave leakage prevention is further improved (first to third embodiments).

5) The space, in which the electric circuit boards including the X-driver substrate at the back of the chassis and IC provided on the TCP wiring connecting the image display panel and the electric circuit boards are included, is separated from the space on the display surface side of the image display panel by the electromagnetic wave shielding structure formed by the chassis at the back of the image display panel constituting the image display apparatus, the frame portion, and the elastic member. Further, the image display panel is covered with the front plate, and the surface of the image display panel is unprocessed. Therefore, while the electromagnetic wave leakage can further be decreased, the image display panel is protected and the process yield is improved (second and third embodiments).

6) The space including the electric circuit boards and IC is formed as the first approximately closed space by the chassis at the back of the image display panel constituting the image display apparatus, the frame portion, and the elastic member. Further, the second approximately closed space is formed by the chassis, the frame portion, the elastic member, and the front plate. Accordingly, since the electromagnetic wave shielding becomes doubled, the reduction performance of the electromagnetic wave leakage to the outside of the chassis can further be improved (third embodiment).

7) The space including the electric circuit boards and IC is shielded at the same potential by the chassis at the back of the image display panel, the electrically-conductive frame-like member, and the electrically-conductive rear cover. Therefore, the electromagnetic wave leakage can further be decreased in the rearward direction of the image display apparatus (first to third embodiments).

8) The space on the display surface side of the image display panel is shielded at the same potential by the chassis at the back of the image display panel, the frame portion, the elastic member, and the electrically conductive front plate. Therefore, the electromagnetic wave leakage can further be decreased in the forward direction of the image display apparatus (third embodiment).

9) In the image display panel in which the electron emission element and the light-emitting member are utilized, since the small amount of electromagnetic wave is generated, the generation of the electromagnetic wave can further be suppressed (first to third embodiments).

This application claims priority from Japanese Patent Application Nos. 2004-191427 filed Jun. 29, 2004, and 2005-137312 filed May 10, 2005, which are hereby incorporated by reference herein.

1. A method of manufacturing an image display apparatus, comprising the steps of:
arranging an electrically conductive member such that at least a part of said electrically conductive member is located between an image display panel and a drive circuit, said electrically conductive member having a hole which passes wiring, said wiring connecting said image display panel and said drive circuit for driving said image display panel;
locating said wiring in the hole, said wiring connecting said image display panel and said drive circuit; and
pushing an electrically-conductive elastic member into the hole.

2. A method of manufacturing an image display apparatus, comprising the steps of:
arranging the first electrically conductive member such that at least a part of said electrically conductive member is located between an image display panel and a drive circuit; and
compressing the second electrically-conductive elastic member by pressing second electrically conductive member against said electrically conductive member through said electrically-conductive elastic member, said second electrically conductive member being different from said electrically conductive member,
wherein wiring is pressed against said electrically conductive member or said second electrically conductive member by the step of compressing said elastic member, said wiring connecting said image display panel and said drive circuit.

3. An image display apparatus comprising:
an image display panel;
a drive circuit which drives said image display panel;
an electrically conductive member which is located between said image display panel and said drive circuit, said electrically conductive member having a hole;
wiring which connects said image display panel and said drive circuit through the hole; and
an elastic member which has electrical conductivity, said elastic member being arranged so as to fill the hole while compressed.

4. An image display apparatus according to claim 3, wherein said elastic member is composed of an insulating elastic member and an electrically conductive material which is formed on surface of the insulating elastic member.

5. An image display apparatus according to claim 3, further comprising a rear cover which has the electrical conductivity, wherein the rear cover and said electrically conductive member form an envelope with which said drive circuit is covered.

6. An image display apparatus according to claim 3, wherein potentials of said electrically conductive member and said elastic member are provided from means for defining a ground potential of said image display panel.

7. An image display apparatus according to claim 3, wherein said electrically conductive member has a positioning portion which positions said elastic member.

8. An image display apparatus according to claim 5, further comprising a front plate which is arranged on a display face side of said image display panel, wherein said front plate is in contact with said electrically conductive member across all the peripheries.

9. An image display apparatus according to claim 8, wherein said front plate has the electrical conductivity.

10. An image display apparatus according to claim 3, wherein said image display panel includes an electron-emitting device and a light-emitting member, the light-emitting member emitting light by causing electrons emitted from the electron-emitting device to be incident to the light-emitting member.

11. An image display apparatus comprising:
an image display panel;
a drive circuit which drives said image display panel;
wiring which connects said image display panel and said drive circuit;
an electrically conductive member which has a hole through which said wiring is passed; and
an elastic member, which has electrically conducting properties, arranged so as to fill the hole while compressed,
wherein said electrically conductive member and said elastic member form an electromagnetic wave shielding structure between a space where said image display panel is located and a space where said drive circuit is located.
